(19) United States
(12) Patent Application Publication
(10) Pub. No.: US 2013/0339839 A1
(43) Pub. Date: Dec. 19, 2013

(54) Analyzing User Interaction

(71) Applicants: Emre Yavuz Baran, London (GB); Jibran Nadir Saithi, London (GB)

(72) Inventors: Emre Yavuz Baran, London (GB); Jibran Nadir Saithi, London (GB)

(21) Appl. No.: 13/523,397

(22) Filed: Jun. 14, 2012

(51) Int. Cl. G06F 17/00

(52) U.S. Cl. 715/234; 715/255

(57) ABSTRACT

Among other things, information is received from a computer system specifying metrics of interaction between a first user of the computer system and objects of a document, each of the metrics being defined at least in part in terms of interactions with the user to which the object is to be sensitive or responsive, and each of the metrics being uniquely identified with respect to the document

### BACKGROUND

This description relates to analyzing user interaction. Most users access the Internet and other networks from a computer system using a web browser. Users interact with the web browser through a variety of means. A user may input a Uniform Resource Locator (URL) address into the web browser's URL bar to directly access a web page of a web site having an address known to the user. Sometimes, a user may use the web browser to access a search engine. The user may then input search terms to find and access web pages not known to the user.

Once a user has accessed a web page, the user may interact with the web page by using a mouse or other input device. If the user is using a touch device such as a smartphone or tablet computer, the user may use a touch input to interact with the web page. Interaction can include the invocation of elements of the web page. To name a few examples of invoking an element: The user may click on hyperlinks situated on the web page to access a completely different web page. The user may click on hyperlinks situated on the web page to access subpages or parent pages of the web page. The user may click on buttons on the web page to trigger pop-up windows without leaving the web page. The user may click on buttons on the web page to change the picture that is displayed. The user may click on drop-down menus on the web page to select different information to be displayed on the page. In some examples, a user may move the mouse cursor around the web page (or touch or use another form of input with the web page) for other reasons.

### SUMMARY

The analysis of user interaction that we describe here may encompass one or more of the following (and other) aspects, features, and implementations, and combinations of them.

In one aspect, in general, a computer-implemented method includes receiving, from a computer system, information specifying metrics of interaction between a first user of the computer system and objects of a document, each of the metrics being defined at least in part in terms of interactions with the user to which the object is to be sensitive or responsive, and each of the metrics being uniquely identified with respect to the document.

Implementations may include one or more of the following features. The method includes providing a report to another user of the first user's interaction with the objects of the document. The report includes visual representations of the metrics displayed simultaneously over visual representations of the objects of the document. The method includes providing an interface to the other user, the interface enabling the other user to select objects of the document for which metrics of interaction are to be recorded. The method includes enabling the other user to indicate the metrics of interaction to be received. The metrics of interaction include at least one of an amount of time the user hovered a cursor over the document object, a number of clicks made by the user on the document object, and scrolling behavior of the user within the document object. The objects of the document are each identified by a unique document object key. At least one of the document object keys includes data derived from markup of the document object that the key identifies. At least one of the document object keys represents a path identifying the document object in a tree of document objects of the document. The method includes analyzing multiple users' interactions with the objects. The method includes deriving statistical information from the analysis.

In another aspect, in general, a computer-implemented method includes receiving, from a computer or mobile device, information specifying metrics of interaction by a user with respect to each of a set of uniquely identified interactive objects that have been presented to the user of the computer or mobile device.

In another aspect, in general, a computer program product stored on a storage device and including a document written in a markup language and defining document objects is configured to cause a first computer system to perform operations including transmitting, to a second computer system, information specifying metrics of interaction between a user of the first computer system and the document objects of the document, the document objects each identified in the information by a unique document object key derived from markup of the respective document object.

In another aspect, in general, a computer-implemented method includes generating a web page that includes document objects defined in a markup language, at least some of the document objects each identifiable by a document object key derived from markup of the respective document object, displaying the web page to a user who interacts with at least some of the document objects using an input device in a web browser application, receiving, from the web browser, data indicative of the interaction between the user and the document objects with which the user interacted, compiling metrics of the user's interaction with the document objects, and displaying a visualization of the metrics of the user's interaction and the document objects.

These and other aspects, features, and implementations, and combinations of them, may be expressed as apparatus, methods, methods of doing business, means or steps for performing functions, components, systems, program products, and in other ways.

Other aspects, features, and advantages will be apparent from the description and the claims.

### DESCRIPTION

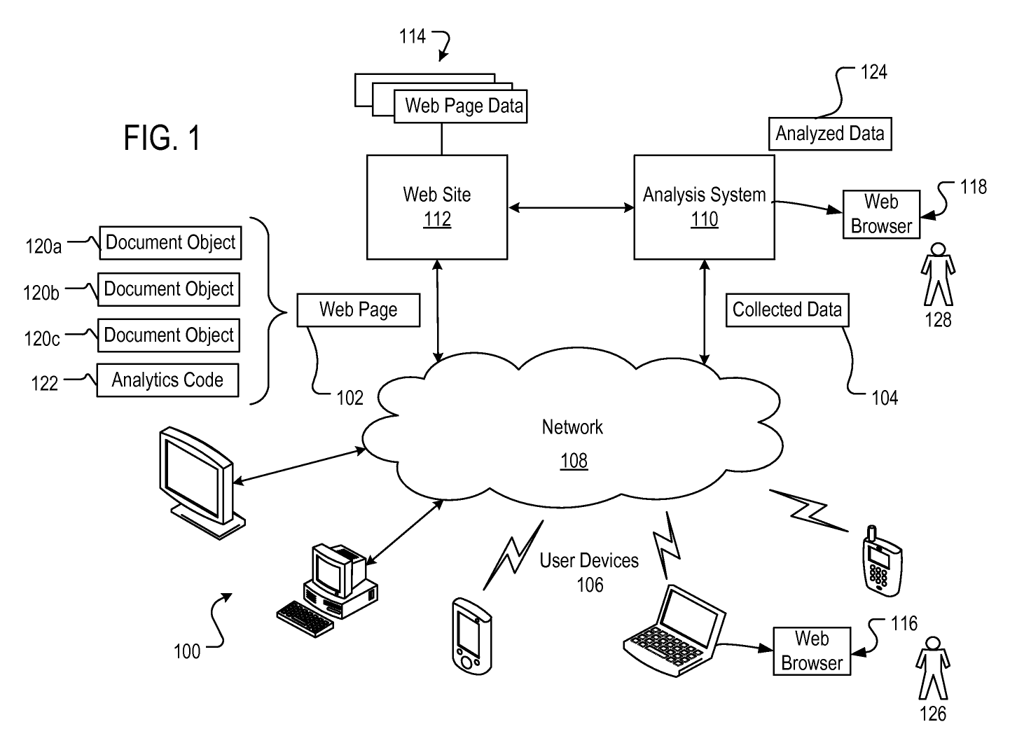

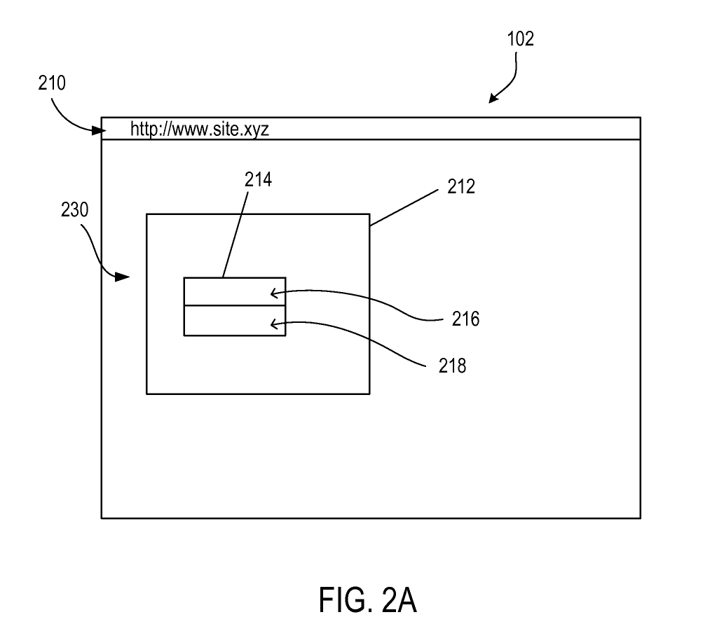

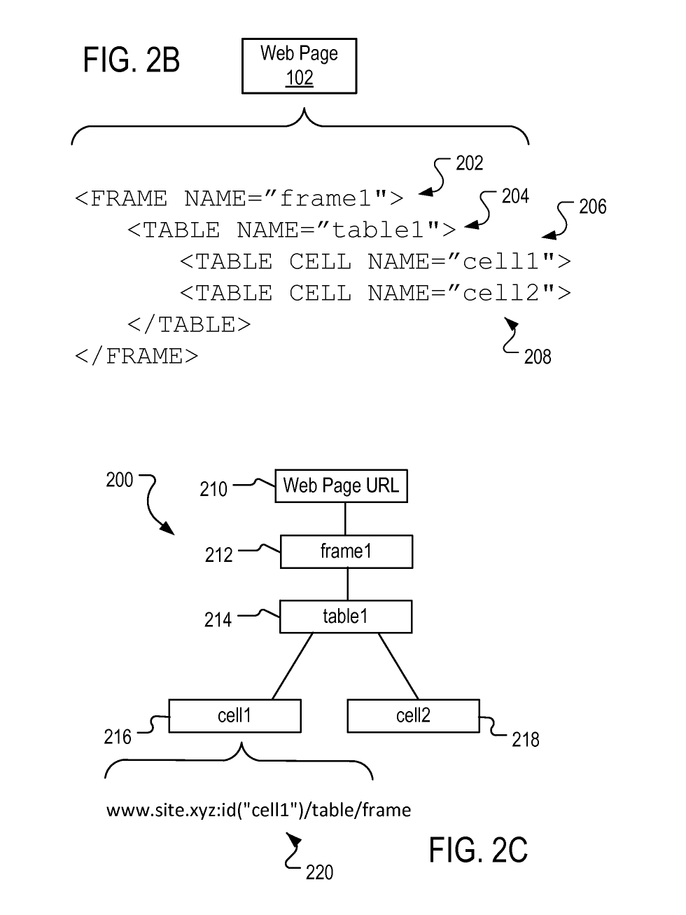

FIGS. 1, 2A-C, and 7 are block diagrams.

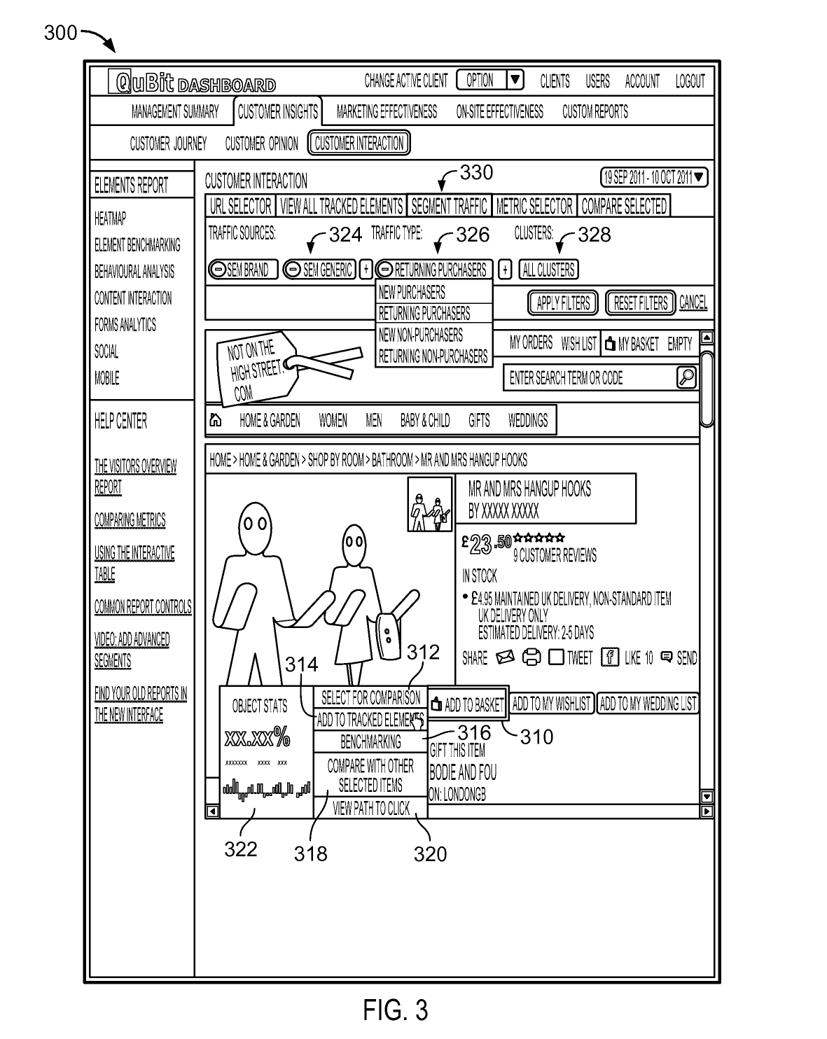

FIGS. 3 through 6 are examples of user interfaces.

### INTRODUCTION

Web site operators sometimes collect data about how users interact with their respective web sites. A web site operator may want to know which portions of web pages that users spend the most or least amount of time looking at or interacting with, for example. Among other purposes, the web site operator can use this information to determine which portions of web pages are popular and unpopular with users and in response make adjustments to the content and layout of web pages to maximize user attention upon particular portions of the web pages.

One way to collect this data is to enable the web page to report back to the web site operator about the user interaction. For example, the web page can include embedded code (e.g., embedded Javascript code) that tracks input device behavior, such as cursor location and clicks made by the user. The embedded Javascript code causes this information to be reported back for analysis. The particular information collected can be described with respect to coordinates on a web page (e.g., a user's cursor hovered over a particular coordinate for a particular amount of time). However, the utility of coordinate information is hindered, for example, when a web page is dynamic (e.g., each user is presented with a customized version of a page, or a given user is presented with different versions of a page or different elements on the page at different times), or when web pages are displayed differently to different users (e.g., due to different ways different web browsers may render the web page).

Another way to describe the collected information is to describe the user's interaction with respect to objects of the web page. By way of background, web pages are usually defined using a markup language such as hypertext markup language (HTML), or an extensible markup language (XML). A web page defined in HTML contains nodes defined by HTML tags. To name a few examples, a page heading defined by a header tag is a node, and an inline graphic defined by an image tag is a node, and a table defined by a table tag is a node (and in turn, the table contains cells which themselves are nodes). Each node is referred to as a document object and can be individually labeled. The tag or tags defining a document object are sometimes referred to as the markup of the document object.

Instead of identifying user interaction with respect to coordinates on a web page, the user interaction can be identified with respect to document objects on the web page. When the embedded Javascript code sends data back to the web site operator describing the user interactions, each interaction is associated with a unique? document object key identifying the particular document object (as well as the coordinates within the document object, in some examples).

An XML document can be modeled as a tree of document objects. The XML document is the parent node of the tree, and document objects of the document are child nodes of the parent node. If a document object is contained within another document object (e.g., a cell contained within a table), then the document object is a child node of the other document object. Each document object in an XML document can be identified by a unique path representing the location of the document object within the tree. Thus, the path can be used as the document object key associated with the user interaction data returned by the Javascript code embedded in an HTML web page.

FIG. 1 is a block diagram of an example environment 100 that allows an analysis system 110 to receive information about a user's 126 interactions with a web site 112.

In some implementations, user devices 106 can be used to access a network 108. A user device 106 can be a computer, laptop, mobile telephone, tablet computer, personal digital assistant, television, touchscreen computer, or other device that can access a network. In some implementations, the user device 106 can access a network 108 through a wired connection. In some implementations, the user device 106 can access the network 108 through a wireless connection (e.g., WiFi, WiMax, or another kind of wireless communication system).

A web browser 116 can operate on the user device 106. Users 126 can use the web browser 116 to communicate with the network 108, e.g., the Internet. In some examples, users 126 can access a web site 112 using the network 108.

Web page data 114 is made available by the web site 112 and can be displayed as one or more web pages 102 on a web browser 116 running on the user device 106. The web page 102 can contain one or more document objects 120a, 120b, 120c. The web page 102 usually defines the document objects 120a, 120b, 120c using a markup language, e.g., HTML or XML.

The web page 102 can be embedded with analytics code 122 that enables the web site 112 to gather collected data 104 about a user's interaction with the web page 102 (and, for example, other web pages). For example, the analytics code 122 could be Javascript code embedded on the web page 102. The analytics code 122 can be configured to track input device behavior of a user 126. The collected data 104 can include information about the behavior of the user 126 while the user 126 interacts with the web page 102 and with the document objects 120a, 120b, 120c of the web page 102.

A web site operator 128 can use a web browser 118 to access an analysis system 110. The analysis system 110 communicates with the web site 112 and receives the collected data 104. In one example, the collected data 104 may remain in its raw form. In some examples, the collected data 104 may be processed and displayed in table format. The collected data 104 can also be analyzed by the analysis system 110 and displayed as analyzed data 124. The web site operator 128 can use a web browser 118 to access the analysis system 110 and view the analyzed data 124. The analysis system 110 can also be configured to provide the web site operator 128 with a report that contains the collected data 104, the analyzed data 124, or both.

In some examples, a web site operator 128 is an entity that creates the content of web pages 102 made available by a web site 112. For example, the web site 112 could be a commercial web site operated by a retail store, and the web site operator 128 can be a person employed by the retail store or a division of a company that manages the retail store. In some examples, a web site operator 128 is an entity that analyses data on behalf of an entity that creates the content of web pages 102 made available by a web site 112. For example, the web site operator 128 could be a system administrator or a consulting firm tasked with analyzing the data.

In some examples, the web site operator 128 can view the collected data 104 before it is analyzed by the analysis system 110. The web site operator 128 can view the collected data in its raw form. In some examples, the web site operator 128 can put the collected data 104 in table format, for example, to improve the readability of the collected data 104. An example of the collected data 104 in table format is shown in Table 1, where the X-axis and Y-axis values indicate the location of the respective element on the web page, in units of pixels.

TABLE 1

| | | X- | Y- | # of | % of |
|---|---|---|---|---|---|
| | | ax- | ax- | inter- | inter- |
| URL address | HTML tag | is | is | actions | actions |
| http://www.site.xyz/ | /html[1] | 37 | 88 | 10 | 74 |
| http://www.site.xyz/ | /html[1]/body[1] | 84 | 54 | 5 | 5 |
| http://www.site.xyz/ | id(“formSendButton”) | 34 | 34 | 2 | 1 |

The first column lists the URL address where each document object (e.g., 120a, 120b, 120c) is defined. The second column lists the HTML tag that defines each document object. The URL address and the HTML tag are combined to create a unique document object key for each document object. The next four columns are examples of metric columns. Each metric column lists collected data 104 that describes either properties of each document object or the user's 126 interaction with each document object. In some examples, a table of the collected data 104 could contain more metrics columns than shown above. Some examples of metrics that describe properties of the document objects and a user's 126 interaction with the document objects are the exact xy position of the cursor within the document object, the scroll offset of the document object from the top of the page if the document object contains a scroll bar or is otherwise only partially visible, the scroll offset of the document object from the left side of the page, the xy position of the left side of the document object, the width of the document object (e.g., column 3), the height of the document object (e.g., column 4), the number of times the cursor touched a part of the document object, the number of times the cursor interacted with the document object (e.g., column 5), the number of times the document object was clicked, the percentage of interactions on the document object relative to the number of interactions of the cursor with document objects on the rest of the web page 102, the percentage of time the cursor spent on the document object relative to the amount of time the cursor spent on other document objects (e.g., column 6), the scrolling behavior of the user 126 within the document object, and the date that the collected data 104 was collected for the document object. In some implementations, the date is recorded when the web page 102 is accessed.

FIG. 2A shows a visual representation of document objects 230 displayed within a web page 102. For example, when the web page 102 is displayed (e.g., in a web browser 116 as shown in FIG. 1), the document objects may be rendered in the form of the visual representation of document objects 230. In some implementations, a user can input the web page URL 210 into the web browser's URL bar to access a web page 102 of a web site 112 (FIG. 1). In this example, the web page 102 is shown as containing frame1 212. Frame 1 212 is shown as containing table1 214. Table 1 214 is shown as containing cell1 216 and cell2 218.

FIG. 2B shows an example of HTML tags that define the document objects shown in the visual representation 230 (FIG. 2A). The document objects populate the web page 102. A unique HTML tag, i.e. ID, is designated for each document object. A document object frame with the name “frame1” is defined by a frame1 markup line 202. A document object table with the name “table1” is defined by a table1 markup line 204. A document object cell with the name “cell1” is defined by a cell1 markup line 206. A document object cell with the name “cell2” is defined by a cell2 markup line 208. In this example, each document object is assigned a name (e.g., “frame1” or “table1”), but in some examples, some or all document objects will not have a name. FIG. 2C shows a tree representation 200 of the document objects from FIGS. 2A and 2B. In this example, the web page URL 210 is the parent node. Frame1 212 is the child node of the web page URL 210. Table1 214 is the child node of frame1 212. Cell1 216 and cell2 218 are child nodes of table1 214. Cell1's 216 location within the tree can be identified by cell1's unique document object key 220.

FIGS. 3-6 show example user interfaces that can be used by the web site operator 128 (FIG. 1).

FIG. 3 shows an example of a user interface 300 of the analysis system 110 (FIG. 1) that can be accessed by the web site operator 128 (FIG. 1). The user interface 300 has many tools and filtering options available to control how the collected data 104 is analyzed and displayed as analyzed data 124. The web site operator 128 can select a document object 310 for analysis. For example, the document object 310 could be an example of one of the document objects 120a, 120b, 120c shown in FIG. 1. Once selected, the web site operator 128 can compare the document object 310 to another document object using the select for comparison button 312 and then the compare with other selected items button 318. The web site operator 128 can also select document objects for which metrics of interaction are to be recorded by using the add to tracked elements button 314. The benchmarking button 316 can be used to access an interface that compares metrics recorded for this document object 310 to benchmark information that represents expected values for the metrics, based on similar document objects. The web site operator 128 can also observe the path the cursor took before clicking the selected document object 310 by using the view path to click button 320. The object stats window 322 can be used to access an interface which displays numerical values (e.g., percentages) for metrics recorded for this document object 310. The web site operator 128 can use the user interface 300 to specify which traffic sources the analysis system 110 considers when analyzing data. The web site operator 128 may use the user interface 300 to instruct the analysis system 110 to analyze only a single user's 126 interaction data. The web site operator may use the user interface 300 to instruct the analysis system 110 to analyze multiple users' 126 interaction data. A SEM brand vs. SEM generic option 324 allows the web site operator 128 to examine metrics calculated from web traffic obtained from different sources. For example, some users may have arrived at the web site 102 from a search engine using a generic search query (e.g., “book store”), while users may have arrived at the web site 102 from a search engine using a branded search query (“LocalBookStore, Inc.”). The SEM brand vs. SEM generic option 324 can be used to separate or include metrics obtained from traffic of these types. The web site operator 128 can also filter traffic by new purchasers, returning purchasers, new non-purchasers, returning non-purchasers, or a combination of one or more of these by selecting the desired traffic type or types in the traffic type menu 326. The web site operator 128 can also use a clusters button 328 to separate traffic based on groupings of users. The groupings could be chosen by the web site operator 128, for example. The web site operator 128 can also use the user interface 300 to instruct the analysis system 110 to derive statistical information from the analysis, e.g., statistics comparing different traffic sources.

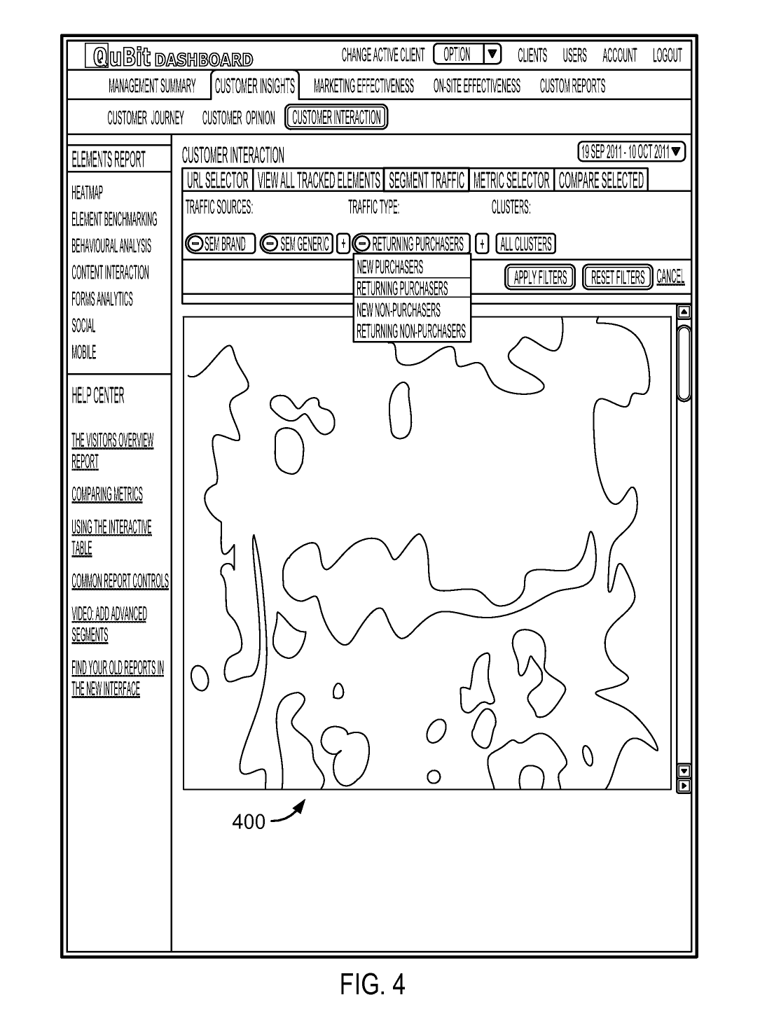

FIG. 4 shows a cursor heat map 400 laid over the web page 102. The cursor heat map 400 is a visual representation of one of the metrics (i.e., the total amount of time the cursor spent on the document object) displayed simultaneously over visual representations of the document objects. In one example, the user 126 may control a cursor using a mouse. In some examples, the user 126 may use a touch input to interact with the web page, e.g., by interacting with a touch screen using a stylus, a finger, or another touch input tool. In one example, the cursor may be visible, e.g., an arrow-shaped pointer on a screen of the user device 106. In some examples, the cursor may be invisible, e.g., a location perceived by a touch screen of the user device 106 based on the location on the screen where the user 126 touches, but not showing any simultaneous visual feedback on the screen to the user 126. The dark areas of the heat map 400 indicate areas where the cursor hovered, with the darker marks indicating more time spent hovering over the area.

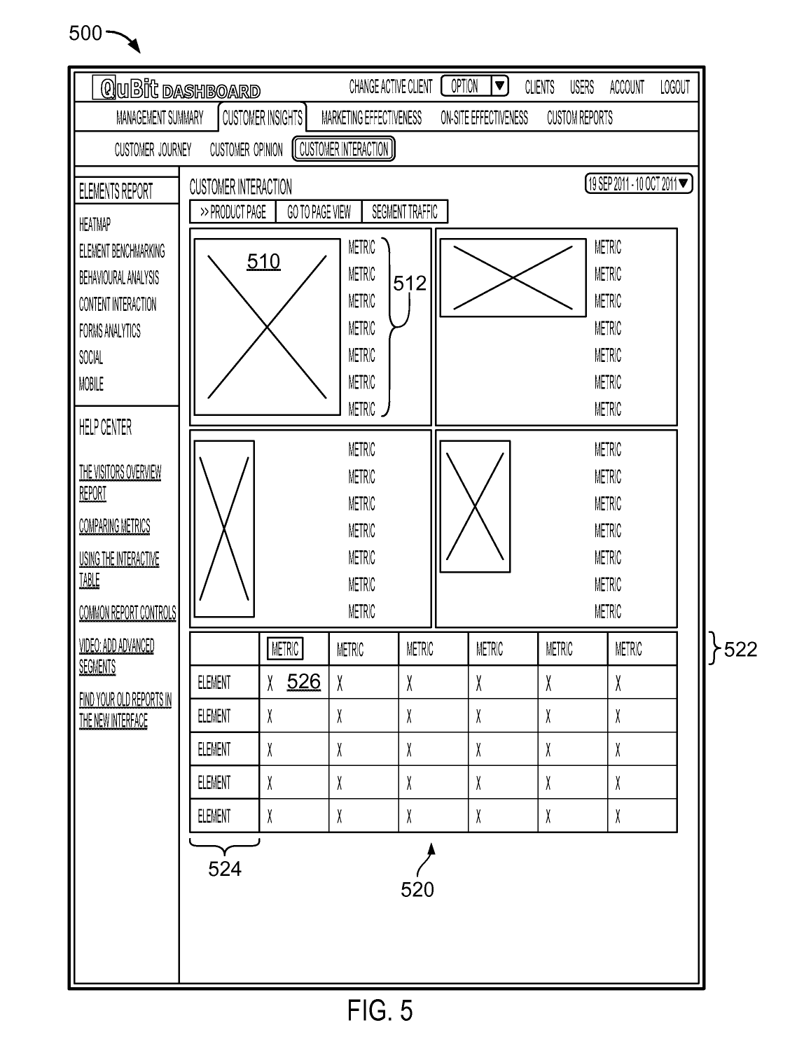

FIG. 5 shows a document object information page 500 that a web site operator 128 can use to view metrics describing document objects (e.g., document objects 120a, 120b, 120c as shown in FIG. 1). Each document object is displayed in the document object's web page form 510. The document object's web page form 510 is accompanied by metric bars 512. The metric bars 512 graphically represent data related to the document object that they accompany. The metric bars 512 can graphically represent data contained in the collected data 104 and the analyzed data 124 (as shown in FIG. 1). The document objects and metric data are also displayed in an element-metric table 520. The document objects are displayed by their HTML tags in an element column 524 that is accompanied by metric columns 522. An element-metric cell 526 indicates the value of a particular metric for a particular document object 120.

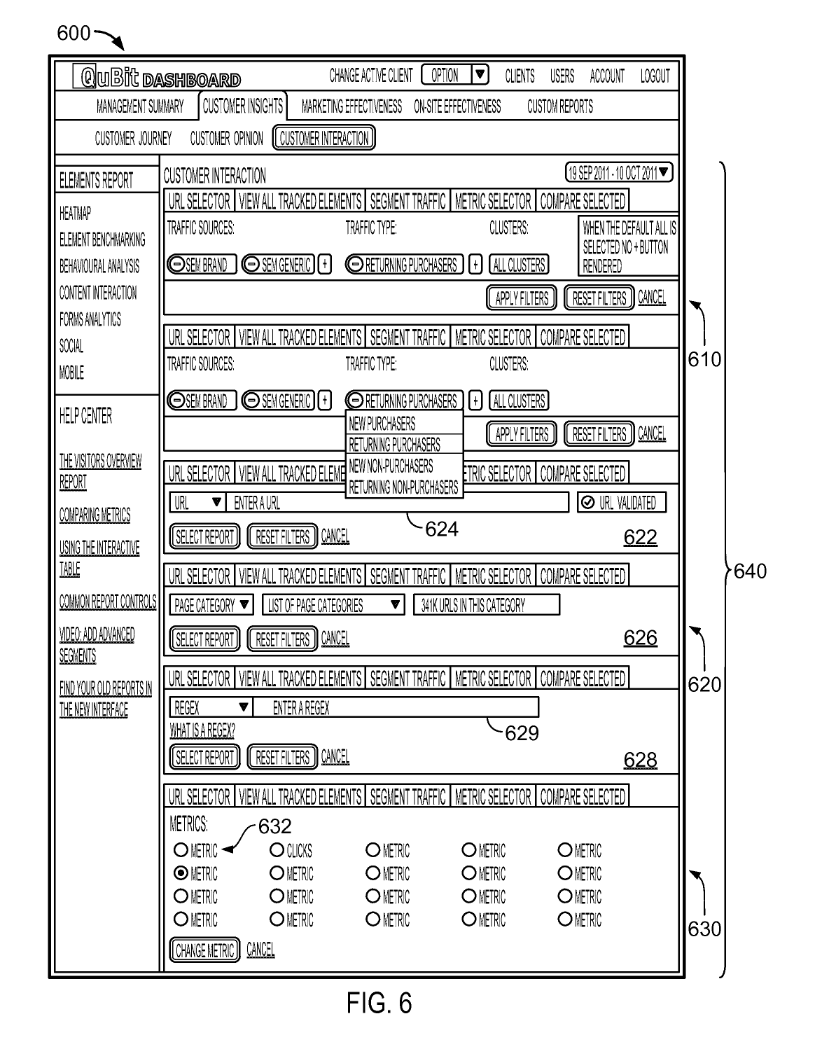

FIG. 6 shows a customization page 600 accessed from the example of a user interface 300. The web site operator 128 can adjust the various parameters on the customization page 600 to control how the analyzed data 124 is analyzed and displayed. Each of the report fields 640 can be customized to analyze data from a URL or group of URLs using a URL selector window 620.

The URL selector window 620 can have multiple forms depending on the web site operator's 128 desired selection method. If the web site operator 128 wants data analyzed for a particular URL, the web site operator 128 can access the URL input window form 622 of the URL selector window 620 and input the URL into the URL field 624. If the web site operator 128 wants data analyzed for a group of URLs, the web site operator 128 can access the page category window form 626 of the URL selector window 620 and select a page category from the page category drop-down menu. If the web site operator 128 wants data analyzed for a regular expression, the web site operator 128 can access the regex window form 628 of the URL selector window 620 and input the regular expression into the regex field 629. For example, data could be analyzed for multiple host names within the “site.xyz” domain by entering a regular expression such as “*.site.xyz.”

The web site operator 128 can use a segment traffic window 610 to choose what kind of traffic is analyzed on the web page (FIG. 1) or group of web pages. The web site operator 128 can specify the traffic sources, traffic types, and clusters to be included in the analysis.

The web site operator 128 can use a metric selector window 630 to choose which metrics are analyzed on the web page (FIG. 1) or group of web pages. The web site operator 128 can select the metric selection button 632 that corresponds to each of the metrics that the web site operator 128 would like to have analyzed.

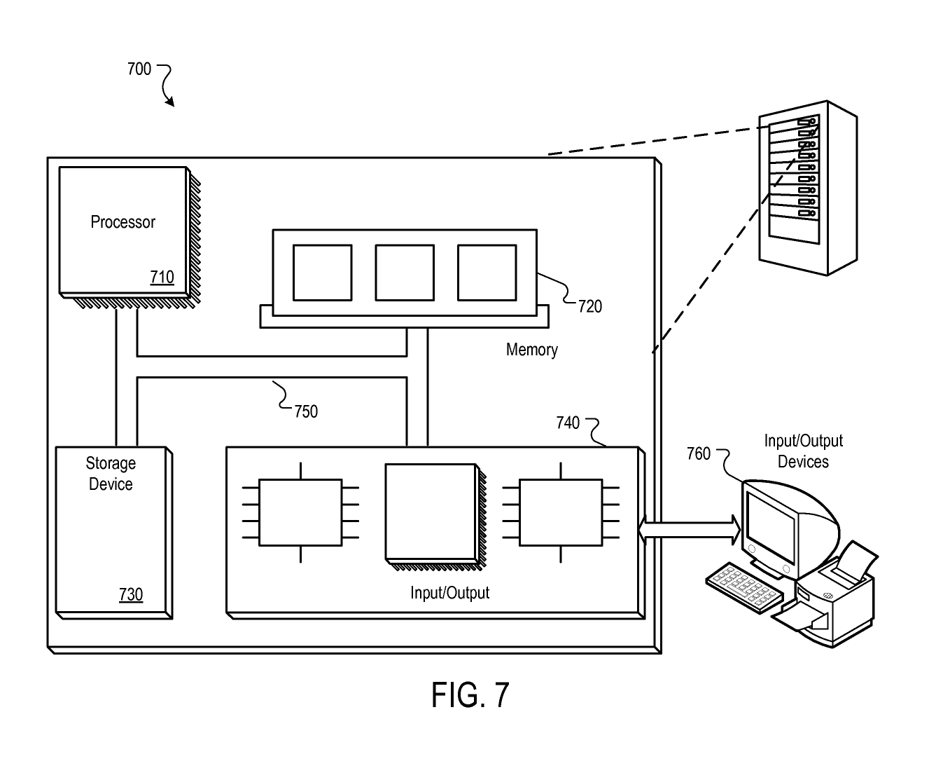

FIG. 7 is a block diagram of an example computer system 700. For example, referring to FIG. 1, the web site 112 could operate on one or more servers implemented as the computer system 700 described here. Any of the user devices 106 could be an example of the computer system 700, and the web browsers 116, 118 could operate on some examples of the system 700. The computer system 700 includes a processor 710, a memory 720, a storage device 730, and an input/output device 740. Each of the components 710, 720, 730, and 740 can be interconnected, for example, using a system bus 750. The processor 710 is capable of processing instructions for execution within the system 700. In some implementations, the processor 710 is a single-threaded processor. In some implementations, the processor 710 is a multi-threaded processor. In some implementations, the processor 710 is a quantum computer. The processor 710 is capable of processing instructions stored in the memory 720 or on the storage device 730.

The memory 720 stores information within the system 700. In some implementations, the memory 720 is a computer-readable medium. In some implementations, the memory 720 is a volatile memory unit. In some implementations, the memory 720 is a non-volatile memory unit.

The storage device 730 is capable of providing mass storage for the system 700. In some implementations, the storage device 730 is a computer-readable medium. In various different implementations, the storage device 730 can include, for example, a hard disk device, an optical disk device, a solid-date drive, a flash drive, magnetic tape, or some other large capacity storage device. The input/output device 740 provides input/output operations for the system 700. In some implementations, the input/output device 740 can include one or more of a network interface devices, e.g., an Ethernet card, a serial communication device, e.g., an RS-232 port, and/or a wireless interface device, e.g., an 802.11 card, a 3G wireless modem, a 4G wireless modem, or another interface. A network interface device allows the system 700 to communicate, for example, transmit and receive data over a network (e.g., the network 108 shown in FIG. 1). In some implementations, the input/output device can include driver devices configured to receive input data and send output data to other input/output devices, e.g., keyboard, printer and display devices 760. In some implementations, mobile computing devices, mobile communication devices, and other devices can be used.

A server can be realized by instructions that upon execution cause one or more processing devices to carry out the processes and functions described above. Such instructions can comprise, for example, interpreted instructions such as script instructions, or executable code, or other instructions stored in a computer readable medium. A server can be distributively implemented over a network, such as a server farm, or a set of widely distributed servers or can be implemented in a single virtual device that includes multiple distributed devices that operate in coordination with one another. For example, one of the devices can control the other devices, or the devices may operate under a set of coordinated rules or protocols, or the devices may be coordinated in another fashion. The coordinated operation of the multiple distributed devices presents the appearance of operating as a single device.

Although an example processing system has been described, implementations of the subject matter and the functional operations described above can be implemented in other types of digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible program carrier, for example a computer-readable medium, for execution by, or to control the operation of, a processing system. The computer readable medium can be a machine readable storage device, a machine readable storage substrate, a memory device, a composition of matter effecting a machine readable propagated signal, or a combination of one or more of them.

The term “system” may encompass all apparatus, devices, and machines for processing data, including by way of example a programmable processor, a computer, or multiple processors or computers. A processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, executable logic, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Computer readable media suitable for storing computer program instructions and data include all forms of non-volatile or volatile memory, media and memory devices, including by way of example semiconductor memory devices, e.g., EPROM, EEPROM, and flash memory devices; magnetic disks, e.g., internal hard disks or removable disks or magnetic tapes; magneto optical disks; and CD-ROM and DVD-ROM disks. The processor and the memory can be supplemented by, or incorporated in, special purpose logic circuitry. Sometimes a server is a general purpose computer, and sometimes it is a custom-tailored special purpose electronic device, and sometimes it is a combination of these things.

Implementations can include a back end component, e.g., a data server, or a middleware component, e.g., an application server, or a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

Certain features that are described that are described above in the context of separate implementations can also be implemented in combination in a single implementation. Conversely, features that are described in the context of a single implementation can be implemented in multiple implementations separately or in any sub-combinations.

The order in which operations are performed as described above can be altered. In certain circumstances, multitasking and parallel processing may be advantageous. The separation of system components in the implementations described above should not be understood as requiring such separation.

Other implementations are within the scope of the following claims.

1. A computer-implemented method comprising
receiving, from a computer system, information specifying metrics of interaction between a first user of the computer system and objects of a document,
each of the metrics being defined at least in part in terms of interactions with the user to which the object is to be sensitive or responsive, and
each of the metrics being uniquely identified with respect to the document.

2. The method of claim 1 comprising providing a report to another user of the first user's interaction with the objects of the document.

3. The method of claim 2 in which the report includes visual representations of the metrics displayed simultaneously over visual representations of the objects of the document.

4. The method of claim 2 comprising providing an interface to the other user, the interface enabling the other user to select objects of the document for which metrics of interaction are to be recorded.

5. The method of claim 4 comprising enabling the other user to indicate the metrics of interaction to be received.

6. The method of claim 1 in which the metrics of interaction include at least one of an amount of time the user hovered a cursor over the document object, a number of clicks made by the user on the document object, and scrolling behavior of the user within the document object.

7. The method of claim 1 in which the objects of the document are each identified by a unique document object key.

8. The method of claim 7 in which at least one of the document object keys includes data derived from markup of the document object that the key identifies.

9. The method of claim 7 in which at least one of the document object keys represents a path identifying the document object in a tree of document objects of the document.

10. The method of claim 1 comprising analyzing multiple users' interactions with the objects.

11. The method of claim 10 comprising deriving statistical information from the analysis.

12. A computer-implemented method comprising
receiving, from a computer or mobile device, information specifying metrics of interaction by a user with respect to each of a set of uniquely identified interactive objects that have been presented to the user of the computer or mobile device.

13. A computer program product stored on a storage device and comprising a document written in a markup language and defining document objects, the computer program product being configured to cause a first computer system to perform operations comprising:
transmitting, to a second computer system, information specifying metrics of interaction between a user of the first computer system and the document objects of the document, the document objects each identified in the information by a unique document object key derived from markup of the respective document object.

14. A computer-implemented method comprising:
generating a web page that includes document objects defined in a markup language, at least some of the document objects each identifiable by a document object key derived from markup of the respective document object;
displaying the web page to a user who interacts with at least some of the document objects using an input device in a web browser application;
receiving, from the web browser, data indicative of the interaction between the user and the document objects with which the user interacted;
compiling metrics of the user's interaction with the document objects; and
displaying a visualization of the metrics of the user's interaction and the document objects.
